(19) United States
(12) Patent Application Publication
(10) Pub. No.: US 2025/0232432 A1
(43) Pub. Date: Jul. 17, 2025

(54) VEHICLE MANAGEMENT DEVICE, SYSTEM, METHOD, AND COMPUTER-READABLE MEDIUM

(71) Applicant: Masayasu HIRATA

(72) Inventor: Masayasu HIRATA

(21) Appl. No.: 18/701,972

(22) PCT Filed: Nov. 4, 2021
(86) PCT No.: PCT/JP2021/040604

§ 371 Date: Apr. 17, 2024

(51) Int. Cl. G06T 7/00; G06Q 30/0645; G06T 7/194; G06T 7/90; G06V 10/26; G06V 10/56; G06V 20/62

(52) U.S. Cl. CPC G06T 7/001; G06Q 30/0645; G06T 7/194; G06T 7/90; G06V 10/26; G06V 10/56; G06V 20/625; G06T 2207/30252

(57) ABSTRACT

An image acquisition means acquires a first image captured at a first time using a camera. The image acquisition means also acquires a second image captured at a second time using the camera. A vehicle type information acquisition means acquires vehicle type information of a vehicle. An image processing means compares the first image and the second image by using image processing logic corresponding to the acquired vehicle type information. A detection means detects damage caused to the vehicle based on a result of the comparison in the image processing means.

### TECHNICAL FIELD

The present disclosure relates to a vehicle management device, a system, a method, and a computer-readable medium.

### BACKGROUND ART

In general, a user who rents a vehicle from a car rental company visually checks damage such as a scratch or a dent of the vehicle together with an employee (clerk) of the car rental company at a store of the car rental company before renting the vehicle. When the vehicle is returned, the user and the clerk visually check the damage or the like of the vehicle again. By checking the damage of the vehicle both before and after the renting of the vehicle, it is possible to determine whether the damage is damage caused by the user or damage present before the renting when the vehicle is damaged.

As related technology, Patent Literature 1 discloses a vehicle management server that manages a vehicle to be rented to a user such as a rental car. In Patent Literature 1, a user terminal having a camera is used for checking damage. The user terminal is configured as a tablet terminal or a smartphone in which a dedicated application is installed. Before using the rental car, the user captures front, rear, left, and right images of the vehicle using the user terminal. The user terminal transmits the captured images (pre-ride images) to the vehicle management server. When the user returns the rental car, the user captures front, rear, left, and right images of the vehicle using the user terminal. The user terminal transmits the captured images (post-ride images) to the vehicle management server.

The vehicle management server compares the pre-ride images with the post-ride vehicle. The vehicle management server determines whether or not there is a change equal to or larger than a set threshold in the pre-ride images and the post-ride images. When it is determined that there is the change equal to or larger than the threshold in the pre-ride images and the post-ride images, the vehicle management server transmits a vehicle confirmation alert indicating a possibility that new damage such as a scratch or a dent has occurred in the vehicle to an administrator terminal. In Patent Literature 1, a vehicle renter can appropriately manage whether or not the user has caused damage such as a scratch or a dent in the vehicle by using the images transmitted from the user terminal. In addition, the user can prove that the user has not caused new damage such as a scratch or a dent in the vehicle while using the vehicle.

### CITATION LIST

### Patent Literature

Patent Literature 1: Japanese Patent No. 6830690

### SUMMARY OF INVENTION

### Technical Problem

In general, a car rental company has vehicles of a plurality of vehicle types, and a vehicle rented to a user is not a single vehicle type. When the presence or absence of the damage is inspected using camera images, it is considered that the appearance of the vehicle in the camera images changes according to the vehicle type. In this case, if image comparison is performed on vehicles of different vehicle types using the same image processing logic, it is considered that the image comparison cannot be efficiently performed. In Patent Literature 1, the pre-ride images and the post-ride images are captured by the user, and a difference in appearance of the vehicle according to the vehicle type in these images is not considered. Therefore, the vehicle management server described in Patent Literature 1 cannot efficiently inspect whether or not the vehicle is damaged according to the vehicle type.

In view of the above circumstances, an object of the present disclosure is to provide a vehicle management device, a system, a method, and a computer-readable medium capable of efficiently inspecting whether or not a vehicle is damaged according to a vehicle type.

### Solution to Problem

In order to achieve the above object, a first aspect of the present disclosure provides a vehicle management device. The vehicle management device includes: an image acquisition means for acquiring a first image captured before a vehicle is rented to a user by using one or more cameras that capture an image of the vehicle to be rented to the user and a second image captured after the vehicle is rented to the user by using the cameras; a vehicle type information acquisition means for acquiring vehicle type information of the vehicle; an image processing means for comparing the first image and the second image by using image processing logic corresponding to the acquired vehicle type information; and a detection means for detecting damage caused to the vehicle based on a result of the comparison in the image processing means.

A second aspect of the present disclosure provides a vehicle management system. The vehicle management system includes: one or more cameras that capture an image of a vehicle to be rented to a user; and a vehicle management device that is used to manage the vehicle. The vehicle management device includes: an image acquisition means for acquiring a first image captured before the vehicle is rented to the user by using the cameras and a second image captured after the vehicle is rented to the user by using the cameras; a vehicle type information acquisition means for acquiring vehicle type information of the vehicle; an image processing means for comparing the first image and the second image by using image processing logic corresponding to the acquired vehicle type information; and a detection means for detecting damage caused to the vehicle based on a result of the comparison in the image processing means.

A third aspect of the present disclosure provides a vehicle management method. The vehicle management method includes: acquiring a first image captured before a vehicle is rented to a user by using one or more cameras that capture an image of the vehicle to be rented to the user and a second image captured after the vehicle is rented to the user by using the cameras; acquiring vehicle type information of the vehicle; comparing the first image and the second image by using image processing logic corresponding to the acquired vehicle type information; and detecting damage caused to the vehicle based on a result of the comparison.

A fourth aspect of the present disclosure provides a computer-readable medium. The computer-readable medium stores a program for causing a computer to execute processing including: acquiring a first image captured before a vehicle is rented to a user by using one or more cameras that capture an image of the vehicle to be rented to the user and a second image captured after the vehicle is rented to the user by using the cameras; acquiring vehicle type information of the vehicle; comparing the first image and the second image by using image processing logic corresponding to the acquired vehicle type information; and detecting damage caused to the vehicle based on a result of the comparison.

### Advantageous Effects of Invention

A vehicle management device, a system, a method, and a computer-readable medium according to the present disclosure can efficiently inspect whether or not a vehicle is damaged according to a vehicle type.

### BRIEF DESCRIPTION OF DRAWINGS

FIG. 1 is a block diagram illustrating a schematic configuration of a vehicle management system according to the present disclosure.

FIG. 2 is a block diagram illustrating a vehicle management system according to an example embodiment of the present disclosure.

FIG. 3 is a schematic diagram illustrating an arrangement example of a camera.

FIG. 4 is a diagram illustrating an example of reservation information.

FIG. 5 is a diagram illustrating an example of vehicle information.

FIG. 6 is a block diagram illustrating a configuration example of an image processing unit.

FIG. 7 is a flowchart illustrating an operation procedure in a vehicle management device.

FIG. 8 is a block diagram illustrating a configuration example of a computer device.

### EXAMPLE EMBODIMENT

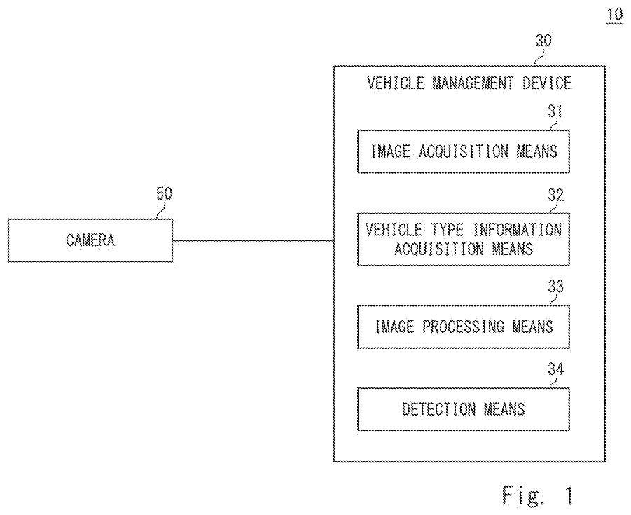

Prior to describing an example embodiment of the present disclosure, an overview of the present disclosure will be described. FIG. 1 illustrates a schematic configuration of a vehicle management system according to the present disclosure. A vehicle management system 10 includes a vehicle management device 30 and one or more cameras 50. The camera 50 is a camera that captures an image of a vehicle to be rented to a user. The vehicle management device 30 is a device used for managing the vehicle to be rented to the user.

The vehicle management device 30 includes an image acquisition means 31, a vehicle type information acquisition means 32, an image processing means 33, and a detection means 34. The image acquisition means 31 acquires a first image captured by using the camera 50 at a first time. In addition, the image acquisition means 31 acquires a second image captured by using the camera 50 at a second time after the first time.

The vehicle type information acquisition means 32 acquires vehicle type information of the vehicle to be rented to the user. The image processing means 33 compares the first image and the second image by using image processing logic corresponding to the vehicle type information acquired by the vehicle type information acquisition means 32. The detection means 34 detects damage caused to the vehicle based on a result of the comparison in the image processing means 33.

In the present disclosure, the image processing means 33 compares the first image and the second image by the image processing logic corresponding to the vehicle type information of the vehicle. For example, if the first image and the second image are compared by the same image processing logic in a case where the vehicle is large and a case where the vehicle is small, it is considered that there is a case where the images cannot be accurately and efficiently compared. In contrast, in the present disclosure, the images are compared using the image processing logic corresponding to the vehicle type. Therefore, the present disclosure can efficiently inspect whether or not the vehicle is damaged.

Hereinafter, example embodiments according to the present disclosure will be described in detail with reference to the drawings. Note that in the description and drawings to be described below, omission and simplification are made as appropriate, for clarity of description. Further, in each of the drawings, the same elements and similar elements are denoted by the same reference signs, and a duplicate description is omitted as necessary.

FIG. 2 illustrates a vehicle management system according to an example embodiment of the present disclosure. A vehicle management system 100 includes a vehicle management device 110, a database 130, and a camera 150. The vehicle management device 110 is a device for managing a vehicle to be rented to a user, such as a rental car. The camera 150 captures an image of the vehicle to be rented to the user. The camera 150 is arranged in each of a plurality of stores of a car rental company, for example. Although only one camera 150 is illustrated in FIG. 1, the number of cameras 150 is not limited to one. A plurality of cameras 150 may be arranged in one store. The vehicle management device 110 corresponds to the vehicle management device 30 illustrated in FIG. 1. The camera 150 corresponds to the camera 50 illustrated in FIG. 1.

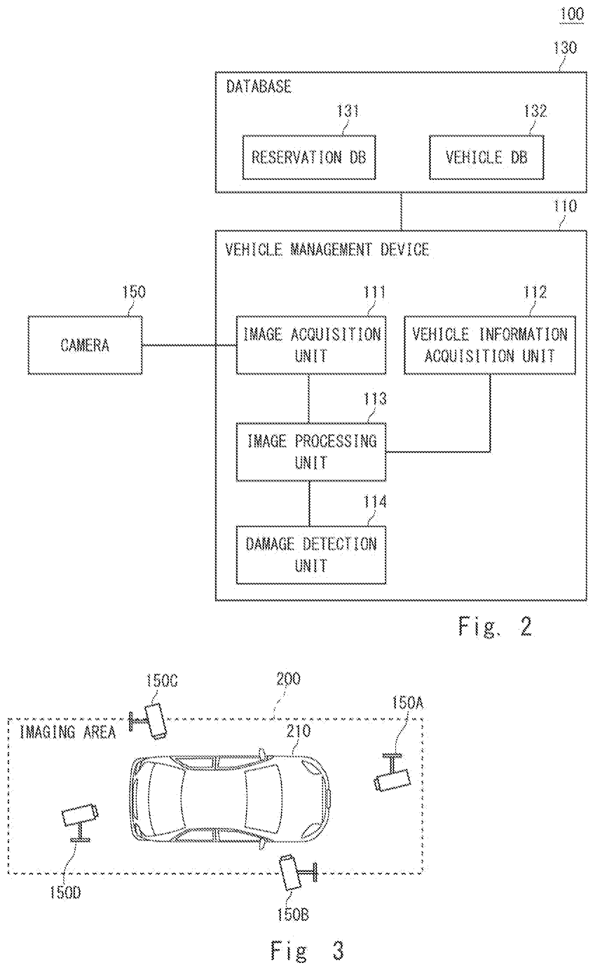

FIG. 3 illustrates an arrangement example of the camera 150. In the example of FIG. 3, four cameras 150A to 150D are arranged in an imaging area 200. A vehicle 210 is a vehicle to be rented to the user. The camera 150A captures an image of the vehicle 210 from the front side of the vehicle. The camera 150B captures an image of the vehicle 210 from the right side of the vehicle. The camera 150C captures an image of the vehicle 210 from the left side of the vehicle. The camera 150D captures an image of the vehicle 210 from the rear side of the vehicle. Instead of using the plurality of fixed cameras 150A to 150D, the camera 150 may be moved to capture an image of the vehicle 210 from a plurality of directions.

The imaging area 200 is a damage check zone and is provided, for example, on a passage through which a vehicle to be rented to the user or a vehicle to be returned passes. In a store (departure store) where the vehicle is rented to the user, a plurality of imaging areas 200 (damage check zones) may be provided. Further, in a store (return store) where the user returns the vehicle, a plurality of imaging areas 200 (damage check zones) may be provided. The imaging area 200 may be provided in a parking lot. The imaging area 200 may be surrounded by an enclosure or the like so that the brightness of the image or the like is not affected by the weather.

When the vehicle 210 is rented to the user, an image of the vehicle 210 is captured using the cameras 150A to 150D in the imaging area 200. For example, when the user rents the vehicle, the user moves the vehicle 210 to the imaging area 200 which is the damage check zone provided in the store. When another vehicle already exists in the imaging area 200, the user waits before the imaging area 200. After the image of the vehicle 210 is captured using the cameras 150A to 150D, the user drives the vehicle 210 and starts moving.

When the user returns the vehicle 210, an image of the vehicle 210 is captured using the cameras 150A to 150D in the imaging area 200. For example, when the user returns the vehicle 210 to the store, the user moves the vehicle 210 to the imaging area 200 which is the damage check zone. After the image of the vehicle 210 is captured in the imaging area 200, the user performs a return procedure of the vehicle 210. Note that the renting store and the return store are not necessarily the same, and may be different. For example, the user may rent the vehicle 210 in an A city and return the vehicle 210 in a B city.

Returning to FIG. 2, the database 130 includes a reservation database (DB) 131 and a vehicle DB 132. The reservation DB 131 is a database that stores reservation information of the user. The vehicle DB 132 is a database that stores information (vehicle information) of the vehicle 210 to be rented to the user.

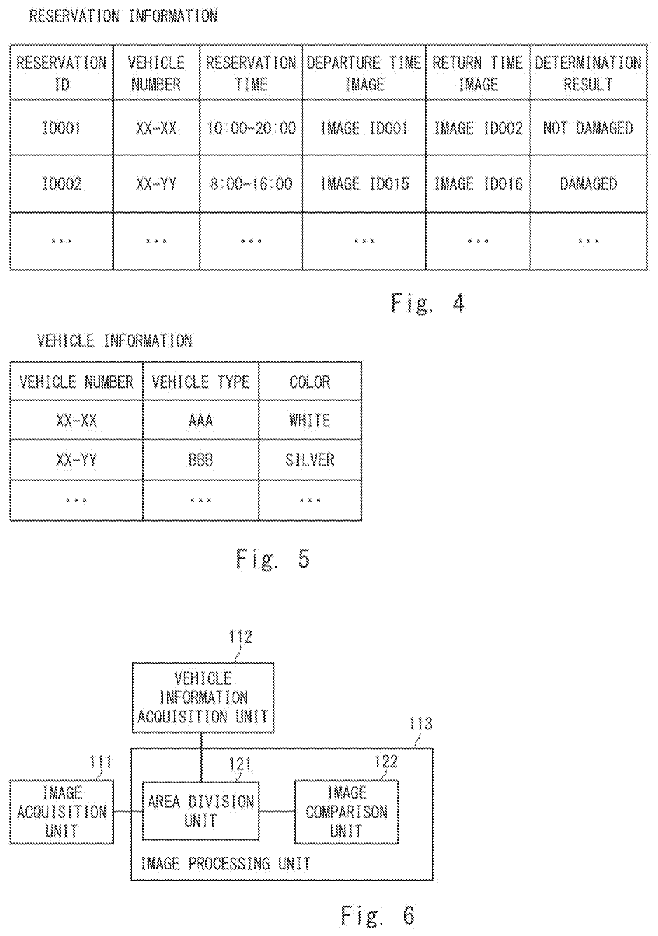

FIG. 4 illustrates an example of the reservation information. In the example of FIG. 4, the reservation information includes a reservation identifier (ID), a reservation time, a departure time image, a return time image, and a determination result. The reservation ID is identification information for uniquely identifying the reservation information. The vehicle number indicates a registration number of the vehicle 210 to be rented to the user. The reservation time indicates a reservation date and time. The departure time image indicates identification information of an image captured by the camera 150 when the vehicle 210 (see FIG. 3) is rented. The return time image indicates identification information of an image captured by the camera 150 when the vehicle 210 is returned. The determination result indicates a determination result of the presence or absence of damage to be described later. The reservation information may further include a departure store and a return store. The reservation information may include the presence or absence of an insurance/compensation contract such as a collision damage waiver (CDW).

FIG. 5 illustrates an example of the vehicle information. In the example of FIG. 5, the vehicle information includes a vehicle number, a vehicle type, and a color. The vehicle number indicates a registration number of the vehicle 210. The vehicle type indicates a vehicle type of the vehicle 210. The vehicle type indicates, for example, a vehicle name or a model name of the vehicle 210. The color indicates color information of the vehicle 210.

Returning to FIG. 2 again, the vehicle management device 110 includes an image acquisition unit 111, a vehicle information acquisition unit 112, an image processing unit 113, and a damage detection unit 114. The vehicle management device 110 is configured as, for example, a computer device such as a server having one or more memories and one or more processors. At least some of functions of the respective units in the vehicle management device 110 can be implemented by a processor operating according to a program read from a memory. Each unit of the vehicle management device 110 is not necessarily disposed in the same physical device. The vehicle management device 110 may include, for example, a plurality of computer devices connected to each other via a network. The vehicle management device 110 is arranged, for example, in a store or a management center of a car rental company. The vehicle management device 110 may be a cloud server.

The image acquisition unit 111 acquires an image of the vehicle 210 captured using the camera 150. The image acquisition unit 111 acquires, for example, images of a front surface, a rear surface, a right side, and a left side of the vehicle 210. The image acquisition unit 111 acquires an image (first image) of the vehicle 210 captured at a first time and an image (second image) of the vehicle 210 captured at a second time. The first time is, for example, a time before the vehicle is rented to the user. The second time is a time at which the user returns the vehicle 210. Here, it is assumed that the “time at which the user returns the vehicle 210” includes a time point at which the vehicle 210 returns to the store for returning and also includes a time point at which a procedure for returning the vehicle 210 is not completed. The first image is captured at a departure store at the time of departure, for example. The second image is captured at a return store at the time of return, for example. The image acquisition unit 111 corresponds to the image acquisition means 31 illustrated in FIG. 1.

The vehicle information acquisition unit 112 acquires vehicle information of the vehicle 210. The vehicle information includes vehicle type information of the vehicle 210. The vehicle information acquisition unit 112 acquires, for example, identification information of the vehicle 210, and acquires the vehicle type information based on the acquired identification information. For example, a registration number of the vehicle 210 is used as the identification information of the vehicle 210. For example, the vehicle information acquisition unit 112 acquires the registration number (vehicle number) from an image of a number plate included in the image captured using the camera 150. The vehicle information acquisition unit 112 refers to the vehicle DB 132 (see FIG. 5) and acquires a vehicle type (vehicle name) associated with the acquired vehicle number as the vehicle type information. The vehicle information acquisition unit 112 may acquire color information of the vehicle 210 from the vehicle DB 132.

Instead of the above, the vehicle information acquisition unit 112 may acquire the vehicle type information using the reservation DB 131 and the vehicle DB 132. In this case, the vehicle information acquisition unit 112 acquires a vehicle number associated with a reservation ID of the user from the reservation DB 131 (see FIG. 4). The vehicle information acquisition unit 112 refers to the vehicle DB 132 and acquires a vehicle type associated with the acquired vehicle number as the vehicle type information. Note that a method for acquiring the identification information of the vehicle is not particularly limited to the above method. For example, the vehicle information acquisition unit 112 may acquire the identification information from a radio frequency identification (RFID) tag attached to the vehicle 210. The vehicle information acquisition unit 112 corresponds to the vehicle type information acquisition means 32 illustrated in FIG. 1.

The image processing unit 113 performs image processing of comparing the first image and the second image. In the image processing, the image processing unit 113 compares the first image and the second image using image processing logic corresponding to the vehicle type information acquired by the vehicle information acquisition unit 112. In the comparison, the image processing unit 113 dynamically specifies an area corresponding to the vehicle 210 (body thereof) in the image, and compares the first image and the second image in the specified area. For example, the image processing unit 113 may switch a size of an area of the body of the vehicle 210 where a surface faces the camera 150, according to the vehicle type. Since an area where a surface does not face the camera 150 is easily affected by reflection, damage cannot be stably detected. For this reason, the image processing unit 113 may exclude such an area from a comparison object.

For example, the image processing unit 113 may switch an image processing engine used for image processing between a small vehicle and a large vehicle according to the size of the vehicle 210. In addition, the image processing unit 113 may switch setting parameters of the image processing engine between the small vehicle and the large vehicle according to the size of the vehicle 210. The image processing unit 113 may switch the image processing logic according to the color (body color) of the vehicle 210. Furthermore, the image processing unit 113 may switch the image processing logic according to a combination of the color or brightness of the background in the image and the color of the vehicle 210. For example, in a case where the background is dark and the color of the vehicle 210 is dark, it is considered that it is difficult to distinguish between the area of the vehicle and the area of the background in the image. Even in a case where the color of the background and the color of the vehicle 210 are similar, it is considered that it is difficult to distinguish between the area of the vehicle and the area of the background in the image. In a situation where it is difficult to distinguish between the area of the vehicle and the area of the background in the image, the image processing unit 113 may use image processing logic effective for such a situation.

The image processing unit 113 may perform luminance adjustment or the like between the images before the comparison between the first image and the second image. By performing the luminance adjustment, it is possible to reduce a difference in luminance between images captured under different weather conditions. In addition, for example, it is possible to reduce a difference between luminance of an image captured at night and luminance of an image captured under a condition of backlight. In the comparison between the first image and the second image, the image processing unit 113 may detect, using the first image as a reference, how much the second image has changed from the first image. The image processing unit 113 corresponds to the image processing means 33 illustrated in FIG. 1.

FIG. 6 illustrates a configuration example of the image processing unit 113. The image processing unit 113 includes an area division unit 121 and an image comparison unit 122. The area division unit 121 divides the image acquired by the image acquisition unit 111 into a plurality of areas according to the vehicle type information acquired by the vehicle information acquisition unit 112. The area division unit 121 divides the image captured by the camera 150 into a first area including only the background, a second area including both the background and the vehicle 210 (body thereof), and a third area including only the vehicle 210. The area division unit 121 divides the first image acquired by the image acquisition unit 111 into a first area, a second area, and a third area. The area division unit 121 divides the second image acquired by the image acquisition unit 111 into a first area, a second area, and a third area.

For example, in a case where the vehicle 210 is a small vehicle, it is considered that the image divided by the area division unit 121 includes a large number of first areas and second areas as compared with a vehicle having a standard size. On the other hand, in a case where the vehicle 210 is a large vehicle, it is considered that the image divided by the area division unit 121 includes a large number of second areas and third areas as compared with a vehicle having a standard size. That is, it is considered that a ratio of the first area, the second area, and the third area included in the image divided by the area division unit 121 is different between the small vehicle and the large vehicle.

In the present example embodiment, the area division unit 121 may divide the image into the first area, the second area, and the third area by using image processing logic corresponding to the size of the vehicle 210. For example, in a case where the vehicle 210 is a small vehicle, the area division unit 121 may perform the area division using image processing logic in which the area is divided such that the ratio of the first area and the second area is larger than that in a case of a vehicle having a standard size. In a case where the vehicle 210 is a large vehicle, the area division unit 121 may perform the area division using image processing logic in which the area is divided such that the ratio of the second area and the third area is larger than that in a case of a vehicle having a standard size.

The image comparison unit 122 compares the first image and the second image in the second area and the third area divided by the area division unit 121. That is, the image comparison unit 122 compares the second area of the first image and the second area of the second image. In addition, the image comparison unit 122 compares the third area of the first image and the third area of the second image. Since the first area is an area including only the background and does not include the vehicle 210, the first area is excluded from a comparison object. For example, in the second area and the third area, the image comparison unit 122 detects how much the second image has changed from the first image, for example, for each pixel or for each predetermined block.

The damage detection unit 114 determines the presence or absence of damage such as a scratch or a dent based on a result of the comparison in the image processing unit 113. In other words, the damage detection unit 114 detects the damage caused to the vehicle 210 based on the result of the comparison in the image processing unit 113. For example, the damage detection unit 114 detects a portion where the amount of change from the first image to the second image is equal to or larger than a threshold as a portion where damage occurs in the vehicle 210. The damage detection unit 114 may change the threshold used to determine a damaged portion according to color information of the vehicle 210. In this case, for example, the damaged portion can be determined based on different criteria for a light color and a dark color.

In addition, the damage detection unit 114 may change the threshold according to contract content included in the reservation information of the user. For example, in a case where the user subscribes to the insurance at the time of the contract of the rental car, the user is not charged for the cost even if the vehicle is damaged. The damage detection unit 114 may change the threshold according to whether or not the user subscribes to the insurance. For example, in a case where the user does not subscribe to the insurance, it is preferable to strictly determine the damaged portion in order to clarify where the responsibility lies. In this case, the damage detection unit 114 sets a relatively small value as the threshold. On the other hand, in a case where the user subscribes to the insurance, the damage can be repaired using the insurance, so that the determination of the damaged portion does not need to be very strict. In this case, the damage detection unit 114 may set a relatively large value as the threshold. In a case where the damage is detected, the damage detection unit 114 may output an alert to an employee of a car rental company such as a clerk. The damage detection unit 114 corresponds to the detection means 34 illustrated in FIG. 1.

In a case where the damage is detected, the clerk visually checks the vehicle 210 together with the user to check whether or not the damage has occurred. In a case where the damage is detected, the damage detection unit 114 may display an image of the detected damaged portion in the second image on a display in a highlighted or enlarged manner. The clerk can check the presence or absence of the damage by viewing the image displayed on the display together with the user. The damage detection unit 114 may display an image of a portion (damaged portion) where the damage has been detected in the second image and an image of a portion corresponding to the damaged portion in the first image in a comparable manner. In this case, the clerk and the user can check whether or not the damage already exists at a time point at which the first image is captured. In a case where it is confirmed that there is damage, the clerk performs cost negotiation with the user.

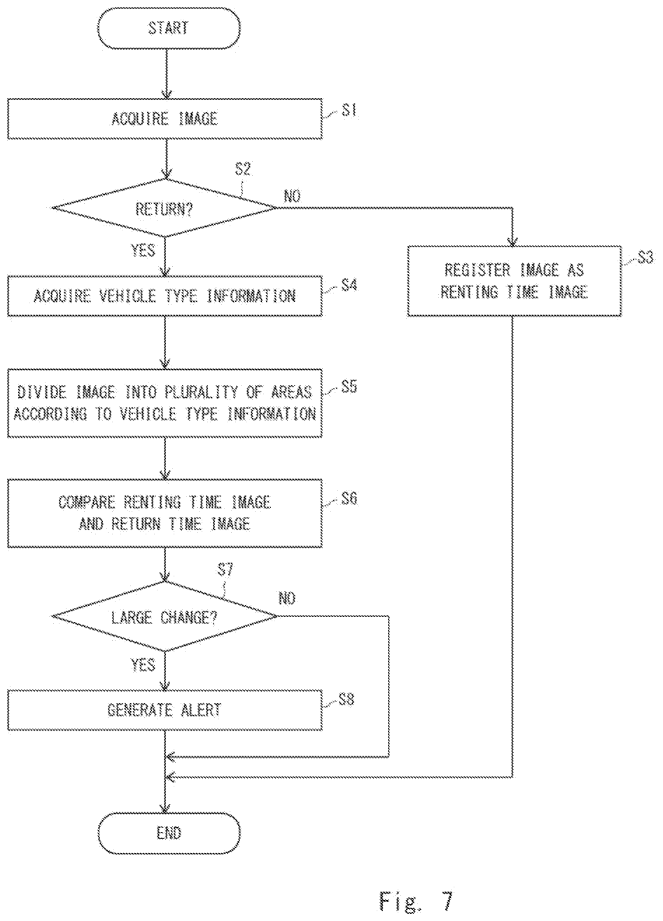

Next, an operation procedure will be described. FIG. 7 illustrates an operation procedure (vehicle management method) in the vehicle management device 110. The image acquisition unit 111 acquires an image captured by the camera 150 (step S1). In step S1, the image acquisition unit 111 acquires, for example, four images captured using the four cameras 150A to 150D (see FIG. 3).

The image acquisition unit 111 determines whether or not the vehicle 210 is a vehicle to be returned (step S2). In step S2, the image acquisition unit 111 refers to, for example, the reservation DB 131 to determine whether the vehicle 210 is a vehicle to be returned or a vehicle to be rented. When it is determined in step S2 that the vehicle 210 is not the vehicle to be returned, the image acquisition unit 111 registers the image acquired in step S1 in the reservation DB 131 (see FIG. 4) as a departure time image (first image) (step S3).

When the vehicle 210 is the vehicle to be returned, the image acquisition unit 111 registers the image acquired in step S1 in the reservation DB 131 as a return time image (second image). When it is determined in step S2 that the vehicle 210 is the vehicle to be returned, the vehicle information acquisition unit 112 acquires vehicle type information of the vehicle 210 (step S4). In step S2, the vehicle information acquisition unit 112 acquires the vehicle type information (vehicle type name) from the vehicle information DB 132 (see FIG. 5), for example.

In the image processing unit 113, the area division unit 121 divides the image acquired by the image acquisition unit 111 into a plurality of areas according to the vehicle type information acquired in step S4 (step S5). For example, in step S5, the area division unit 121 divides each of a departure time image and a return time image into the first area, the second area, and the third area described above. The image comparison unit 122 compares the departure time image and the return time image (step S6). For example, in step S6, the image comparison unit 122 compares the departure time image and the return time image in each of the second area and the third area.

As a result of the comparison in step S6, the damage detection unit 114 determines whether or not the change from the first image to the second image is large (step S7). The damage detection unit 114 registers a determination result of step S7 in the reservation DB 131. When it is determined in step S7 that the change is large, the damage detection unit 114 notifies a clerk of a car rental company or a person in charge of a management department of a damage alert (step S8). In step S8, the damage detection unit 114 notifies the clerk or the person in charge of a portion where the change in the image is large in the vehicle 210, that is, a portion where there is a high possibility that damage occurs in the vehicle 210, for example.

In the present example embodiment, the image processing unit 113 compares the first image to be the departure time image and the second image to be the return time image by the image processing according to the vehicle type information of the vehicle 210. In the image processing unit 113, the area division unit 121 uses the vehicle type information to divide each of the first image and the second image into the first area including only the background, the second area including the background and the vehicle body, and the third area including only the vehicle body. The image comparison unit 122 compares the first image and the second image in the second area and the third area.

When the vehicle 210 is a small vehicle, the divided image includes a large number of first areas. In this case, the image comparison unit 122 does not perform image comparison for the first area that is the background portion. By omitting the image comparison of the background portion, unnecessary image comparison (image inspection) can be suppressed. Therefore, in the present example embodiment, unnecessary calculation resources can be reduced, and cost reduction can be realized. In addition, in the present example embodiment, since it is not generated that damage is erroneously detected by comparing the background portion, it is considered that erroneous detection can be reduced and inspection accuracy can be improved. On the other hand, in a case where the vehicle 210 is a large vehicle, it is considered that the first area included in the divided image is small. In this case, the number of second areas and third areas including the body portion of the vehicle 210 increases, and the comparison areas are wide, so that leakage of image comparison can be suppressed and the inspection accuracy can be improved.

In the present example embodiment, the damage detection unit 114 can detect new damage caused to the vehicle 210 during the renting to the user, based on the comparison result between the first image and the second image compared by the image processing according to the vehicle type information. In the present example embodiment, the image processing unit 113 compares images by the image processing according to the vehicle type information. Therefore, the vehicle management device 110 according to the present example embodiment can efficiently and accurately detect new damage caused to the vehicle 210.

In the present example embodiment, the vehicle management device 110 may hold, for each vehicle type, information indicating which portion in the image is an area where the body surface faces the camera 150. The image processing unit 113 can also perform image comparison using the information. For example, in the image processing unit 113, it is possible to more efficiently inspect whether or not the vehicle 210 is damaged by excluding, from a comparison object, an area which is easily affected by the reflection and in which damage cannot be stably detected due to the influence of the reflection.

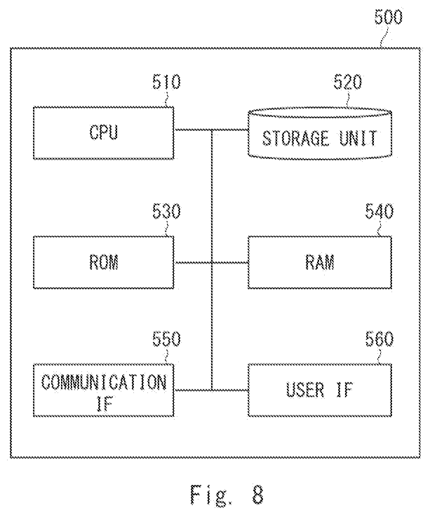

In each of the above example embodiments, the vehicle management device 110 can be configured as a computer device. FIG. 8 illustrates a configuration example of a computer device that can be used as the vehicle management device 110. A computer device 500 includes a control unit (central processing unit (CPU)) 510, a storage unit 520, a read only memory (ROM) 530, a random access memory (RAM) 540, a communication interface (IF) 550, and a user interface 560.

The communication interface 550 is an interface for connecting the computer device 500 to a communication network through wired communication means, wireless communication means, or the like. The user interface 560 includes, for example, a display unit such as a display. The user interface 560 also includes input units such as a keyboard, a mouse, and a touch panel.

The storage unit 520 is an auxiliary storage device that can hold various types of data. The storage unit 520 does not need to be a part of the computer device 500 and may be an external storage device or a cloud storage connected to the computer device 500 via a network.

The ROM 530 is a non-volatile storage device. For example, a semiconductor storage device such as a flash memory having a relatively small capacity may be used for the ROM 530. A program that is executed by the CPU 510 may be stored in the storage unit 520 or the ROM 530. The storage unit 520 or the ROM 530 stores, for example, various programs for implementing the functions of the respective units in the vehicle management device 110.

The program described above includes a group of commands (or software codes) for causing a computer to perform one or more functions described in the example embodiments when being read by the computer. The program may be stored in a non-transitory computer-readable medium or a tangible storage medium. As an example and not by way of limitation, the computer-readable medium or the tangible storage medium includes a RAM, a ROM, a flash memory, a solid-state drive (SSD) or other memory technologies, a compact disc (CD)-ROM, a digital versatile disc (DVD), a Blu-ray (registered trademark) disk or other optical disk storages, a magnetic cassette, a magnetic tape, a magnetic disk storage, or other magnetic storage devices. The program may be transmitted on a transitory computer-readable medium or a communication medium. As an example and not by way of limitation, the transitory computer-readable medium or the communication medium includes propagated signals in electrical, optical, acoustic, or any other form.

The RAM 540 is a volatile storage device. As the RAM 540, various types of semiconductor memory devices such as a dynamic random access memory (DRAM) or a static random access memory (SRAM) may be used. The RAM 540 may be used as an internal buffer for temporarily storing data or the like. The CPU 510 loads a program, stored in the storage unit 520 or the ROM 530, in the RAM 540, and executes the loaded program. The functions of the respective units in the vehicle management device 110 can be implemented by the CPU 510 executing the program. The CPU 510 may include an internal buffer in which data or the like can be temporarily stored.

Although the example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure.

For example, some or all of the above-described example embodiments may be described as the following supplementary notes, but the present disclosure is not limited to the following supplementary notes.

### [Supplementary Note 1]

A vehicle management device including:
an image acquisition means for acquiring a first image captured at a first time using one or more cameras that capture an image of a vehicle to be rented to a user and a second image captured at a second time after the first time using the cameras;
a vehicle type information acquisition means for acquiring vehicle type information of the vehicle;
an image processing means for comparing the first image and the second image by using image processing logic corresponding to the acquired vehicle type information; and
a detection means for detecting damage caused to the vehicle based on a result of the comparison in the image processing means.

### [Supplementary Note 2]

The vehicle management device according to Supplementary Note 1, wherein
the image processing means divides each of the first image and the second image into a first area including only a background, a second area including both the background and the vehicle, and a third area including only the vehicle according to the vehicle type information, and
the image processing means compares the second area of the first image with the second area of the second image, and compares the third area of the first image with the third area of the second image.

### [Supplementary Note 3]

The vehicle management device according to Supplementary Note 1 or 2,
wherein the image processing means detects, using the first image as a reference, how much the second image has changed from the first image in the comparison between the first image and the second image.

### [Supplementary Note 4]

The vehicle management device according to Supplementary Note 3,
wherein the detection means determines that the vehicle is damaged when an amount of change from the first image to the second image is equal to or larger than a threshold.

### [Supplementary Note 5]

The vehicle management device according to Supplementary Note 4, wherein
the vehicle type information acquisition means further acquires color information of the vehicle, and
the detection means changes the threshold according to the color information.

### [Supplementary Note 6]

The vehicle management device according to any one of Supplementary Notes 1 to 5,
wherein the vehicle type information acquisition means acquires identification information of the vehicle, and acquires the vehicle type information based on the acquired identification information.

### [Supplementary Note 7]

The vehicle management device according to Supplementary Note 6,
wherein the vehicle type information acquisition means acquires vehicle type information associated with the acquired identification information from a database that stores the identification information and the vehicle type information.

### [Supplementary Note 8]

The vehicle management device according to Supplementary Note 6,
wherein the vehicle type information acquisition means acquires the identification information from an image of a number plate of the vehicle included in the first image and the second image.

### [Supplementary Note 9]

The vehicle management device according to any one of Supplementary Notes 1 to 8,
wherein the vehicle type information acquisition means acquires a vehicle name of the vehicle as the vehicle type information.

### [Supplementary Note 10]

The vehicle management device according to any one of Supplementary Notes 1 to 9,
wherein the first time is a time before the vehicle is rented to the user, and the second time is a time when the user returns the vehicle.

### [Supplementary Note 11]

The vehicle management device according to any one of Supplementary Notes 1 to 10,
wherein the first image is captured at a departure store at the time of departure, and the second image is captured at a return store at the time of return.

### [Supplementary Note 12]

A vehicle management system including:
one or more cameras configured to capture an image of a vehicle to be rented to a user; and
a vehicle management device used to manage the vehicle,
wherein the vehicle management device includes
an image acquisition means for acquiring a first image captured at a first time using the cameras and a second image captured at a second time after the first time using the cameras,
a vehicle type information acquisition means for acquiring vehicle type information of the vehicle,
an image processing means for comparing the first image and the second image by using image processing logic corresponding to the acquired vehicle type information, and
a detection means for detecting damage caused to the vehicle based on a result of the comparison in the image processing means.

### [Supplementary Note 13]

The vehicle management system according to Supplementary Note 12, wherein
the image processing means divides each of the first image and the second image into a first area including only a background, a second area including both the background and the vehicle, and a third area including only the vehicle according to the vehicle type information, and
the image processing means compares the second area of the first image with the second area of the second image, and compares the third area of the first image with the third area of the second image.

### [Supplementary Note 14]

A vehicle management method including:
acquiring a first image captured at a first time using one or more cameras that capture an image of a vehicle to be rented to a user and a second image captured at a second time after the first time using the cameras;
acquiring vehicle type information of the vehicle;
comparing the first image and the second image by using image processing logic corresponding to the acquired vehicle type information; and
detecting damage caused to the vehicle based on a result of the comparison.

### [Supplementary Note 15]

A non-transitory computer-readable medium that stores a program for causing a computer to execute processing including:
acquiring a first image captured at a first time using one or more cameras that capture an image of a vehicle to be rented to a user and a second image captured at a second time after the first time using the cameras;
acquiring vehicle type information of the vehicle;
comparing the first image and the second image by using image processing logic corresponding to the acquired vehicle type information; and
detecting damage caused to the vehicle based on a result of the comparison.

### REFERENCE SIGNS LIST

10 VEHICLE MANAGEMENT SYSTEM
30 VEHICLE MANAGEMENT DEVICE
31 IMAGE ACQUISITION MEANS
32 VEHICLE TYPE INFORMATION ACQUISITION MEANS
33 IMAGE PROCESSING MEANS
34 DETECTION MEANS
50 CAMERA
100 VEHICLE MANAGEMENT SYSTEM
110 VEHICLE MANAGEMENT DEVICE
111 IMAGE ACQUISITION UNIT
112 VEHICLE INFORMATION ACQUISITION UNIT
113 IMAGE PROCESSING UNIT
114 DAMAGE DETECTION UNIT
121 AREA DIVISION UNIT
122 IMAGE COMPARISON UNIT
130 DATABASE
131 RESERVATION DB
132 VEHICLE DB
150 CAMERA
200 IMAGING AREA
210 VEHICLE

What is claimed is:

1. A vehicle management device comprising:
at least one memory storing instructions; and
at least one processor configured to execute the instructions to:
acquire a first image captured at a first time using one or more cameras that capture an image of a vehicle to be rented to a user and a second image captured at a second time after the first time using the cameras;
acquire vehicle type information of the vehicle;
perform a comparison of the first image and the second image by using image processing logic corresponding to the acquired vehicle type information; and
detect damage caused to the vehicle based on a result of the comparison.

2. The vehicle management device according to claim 1, wherein
the at least one processor is configured to execute the instructions to:
divide each of the first image and the second image into a first area including only a background, a second area including both the background and the vehicle, and a third area including only the vehicle according to the vehicle type information, and
perform a comparison of the second area of the first image with the second area of the second image, and perform a comparison of the third area of the first image with the third area of the second image.

3. The vehicle management device according to claim 1,
wherein the at least one processor is configured to execute the instructions to detect, using the first image as a reference, how much the second image has changed from the first image in the comparison between the first image and the second image.

4. The vehicle management device according to claim 3,
wherein the at least one processor is configured to execute the instructions to determine that the vehicle is damaged when an amount of change from the first image to the second image is equal to or larger than a threshold.

5. The vehicle management device according to claim 4, wherein
the at least one processor is configured to execute the instructions to;
acquire color information of the vehicle, and
change the threshold according to the color information.

6. The vehicle management device according to claim 1,
wherein the at least one processor is configured to execute the instructions to acquire identification information of the vehicle, and acquire the vehicle type information based on the acquired identification information.

7. The vehicle management device according to claim 6,
wherein the at least one processor is configured to execute the instructions to acquire vehicle type information associated with the acquired identification information from a database that stores the identification information and the vehicle type information.

8. The vehicle management device according to claim 6,
wherein the at least one processor is configured to execute the instructions to acquire the identification information from an image of a number plate of the vehicle included in the first image and the second image.

9. The vehicle management device according to claim 1,
wherein the at least one processor is configured to execute the instructions to acquire a vehicle name of the vehicle as the vehicle type information.

10. The vehicle management device according to claim 1,
wherein the first time is a time before the vehicle is rented to the user, and the second time is a time when the user returns the vehicle.

11. The vehicle management device according to claim 1,
wherein the first image is captured at a departure store at the time of departure, and the second image is captured at a return store at the time of return.

12. A vehicle management system comprising:
one or more cameras configured to capture an image of a vehicle to be rented to a user; and
the vehicle management device according to claim 1.

13. The vehicle management system according to claim 12, wherein
the at least one processor is configured to execute the instructions to:
divide each of the first image and the second image into a first area including only a background, a second area including both the background and the vehicle, and a third area including only the vehicle according to the vehicle type information, and
perform a comparison of the second area of the first image with the second area of the second image, and perform a comparison of the third area of the first image with the third area of the second image.

14. A vehicle management method comprising:
acquiring a first image captured at a first time using one or more cameras that capture an image of a vehicle to be rented to a user and a second image captured at a second time after the first time using the cameras;
acquiring vehicle type information of the vehicle;
comparing the first image and the second image by using image processing logic corresponding to the acquired vehicle type information; and
detecting damage caused to the vehicle based on a result of the comparison.

15. A non-transitory computer-readable medium that stores a program for causing a computer to execute processing including:
acquiring a first image captured at a first time using one or more cameras that capture an image of a vehicle to be rented to a user and a second image captured at a second time after the first time using the cameras;
acquiring vehicle type information of the vehicle;
comparing the first image and the second image by using image processing logic corresponding to the acquired vehicle type information; and
detecting damage caused to the vehicle based on a result of the comparison.
